(19) United States
(12) Patent Application Publication
(10) Pub. No.: US 2012/0213617 A1
(43) Pub. Date: Aug. 23, 2012

(54) ANGULAR LOAD SUPPORT AS WELL AS STORAGE AND ORDER-PICKING SYSTEM HAVING AN ANGULAR LOAD SUPPORT BEING APPLICABLE UNIVERSALLY

(76) Inventor: Max Winkler, Graz (AT)

(21) Appl. No.: 13/399,227

(22) Filed: Feb. 17, 2012

Related U.S. Application Data
(63) Continuation of application No. PCT/EP2010/061985, filed on Aug. 17, 2010.

(30) Foreign Application Priority Data
Aug. 17, 2009 (DE) 10 2009 038 124.4

(51) Int. Cl. B65G 65/00; B65D 25/02; B65D 6/00

(52) U.S. Cl. 414/287; 220/4.01; 220/600

(57) ABSTRACT

It is disclosed an angular load support (30) having three sides (32, 34, 36), which are substantially orientated perpendicular to each other and define a first support wall (32), a second support wall (34) and a base (36) for storing the goods (42) in stacks, wherein at least one of the sides (32-36) comprises at least one recess (43) being adapted to removably receiving a fixing bar (38, 40) or to allow reaching through of a separation device (52) of an automatic picking unit (90), or wherein the fixing bars (38, 40) can be mounted variably to the support walls (32-36) by means of magnetic holding elements. (FIG. 7)

### RELATED APPLICATIONS

This is a continuation application of the co-pending International application PCT/EP2010/061985 (WO 2011/020835 A1) filed on Aug. 17, 2010 which claims priority of the German patent application DE 10 2009 038 124.4 filed on Aug. 17, 2009, theses applications being fully incorporated herewith by reference.

### BACKGROUND OF THE INVENTION

The present invention relates to an angular load support as well as a storage and order-picking system having a storage area and a picking area, wherein a universal angular load support is used for both storing and actual picking.

### RELATED PRIOR ART

A storage and order-picking system is known from the German patent applications DE 10 2006 025 620 A1 as well as DE 10 2006 025 618 A1, the system being operated by means of trays in terms of (individual) load supports. A pallet high-bay warehouse can be provided at a goods-receipt end, the warehouse holding completely loaded supply pallets which can be depalletized on demand in layers. In this context, each of the trays receives a complete palette layer consisting of a plurality of individual articles, and is stored in a tray warehouse subsequently. Trays being loaded in this manner are conveyed to a separation station for the purpose of order-picking where individual ones of the articles of the palette layer can be removed from the tray. The removal either happens manually or in an automated manner. Then, the tray is returned to the tray warehouse. If one of the trays is completely empty, then the tray is conveyed back to the depalettizer station at the high-bay warehouse.

The system disclosed in the above-referenced German patent applications is particularly suitable in the field of retail, such as the food industry, in order to supply subsidiaries from a central warehouse.

Typically, smaller articles are stored in so-called automated storage and retrieval systems (AS/RS). An AS/RS often comprises a storage area having racks which are suitable for receiving trays or containers. Storage and retrieval devices move in aisles between the racks, the storage and removal devices being capable of storing and retrieving the trays or containers in an automated manner and of handing-over same to a conveyor. The conveyor transports the trays or containers to manually-operated order-picking stations where the to-be-picked goods are removed manually from the storage trays or storage containers and are given to order containers. Alternatively, the picking process can be performed in a fully-automated manner by means of so-called picking robots as described exemplarily in the German patent application DE 10 2008 046 325 which is completely incorporated herewith by reference. If robots are used for picking, the goods, however, need to be released on a belt conveyor or need to be presented to the robot in specifically designed trays so that the robot can actually grab the goods vertically from above. If the goods are released on the conveyance belt, they are distributed chaotically on the belt so that a vision system needs to be provided in front of the robot for determining in advance (by calculation) the location and orientation of the chaotically distributed goods for the subsequently arranged robot. If the goods are transported to the robot in specific trays, only very specific type of goods can be handled, such as drugs. Goods which are particularly flat such as CDs or books are not suited in particular for the provision in trays since only a few CDs can be arranged (single-high) on the tray.

Further, automatic picking machines are known in the prior art, which are often designated as “A-frames” since the basis frame thereof has a cross section of the letter A. Such an automatic picking machine is described exemplarily in the patent application U.S. Pat. No. 5,271,703.

The German patent application DE 28 45 691 discloses a container for packed goods, the container having three sides. In this context, two sides of a rectangular base plate having different lengths are surrounded by two sidewalls having the same height which are arranged in a rectangular angle relative to each other, wherein two sides of the base plate are open for loading and unloading.

The German patent application DE 102 52 709 A1 discloses a device for stacking pallet having put-on frames. The device comprises a base part and two following side plates which preferably are made of thin sheet metal. These elements are preferably arranged in an angle of 90° relative to each other. In at least one of the sidewalls the apparatus comprises at least one recess extending upwards from the base part parallel to a connecting edge of the sidewalls, in order to allow mounting of fixing ribbons to the goods which are to be stacked in the apparatus.

### SUMMARY OF THE INVENTION

Starting from this prior art, it is an object to provide a storage and order-picking system which allows order-picking of both flat goods such as CDs, packed shirts or books, and other commercially available goods such as drugs, shoes, replacement parts like headlight boxes, etc., in a consistently efficient manner, wherein the system is preferably adapted to realize different order-picking modes such as manual picking and automated picking, e.g. by means of an A-frame or a picking robot. In particular, an angular load support is to be provided which can be utilized in a storage and order-picking system of this type.

This task is solved by an angular load support having three sides which are substantially arranged in right angles to each other and which define a first support wall, a second support wall and a base for storing the goods in stacks, wherein at least one of the three sides of at least some of the angular load supports comprises a recess which is adapted to removably receive a fixing web or to allow a separation device of an automated order-picking unit to reach through, or wherein the fixing webs are mounted variablely to the support walls by means of magnetic support elements.

This object is also solved by a storage and order-picking system, wherein the system comprises a storage area and a picking area, wherein the above-mentioned angular load supports are used for both storage and transportation of to-be-picked goods between the storage area and the picking area. A plurality of existing technologies can be combined with each other due to this system. This results in simple realization processes for both the IT departments and the customers (buyer) of such systems. The solution is scalable and can grow with increasing throughput demands. The solution is suited in an ideal manner for single parts which are regularly geometrical such as the ones being present in the pharmaceutical industry, the cosmetic industry, in the field of media, office equipment, books, toys, electronics, replacement parts and similar things. In this case, only low investments are required.

The storage containers and trays which are typically used in the prior art for storing the goods are replaced with the present invention by a long angle having three sides in which the goods are stacked column-like. The angle (i.e. the angular load support) serves as an order-picking and storage element. The angular load support can be used with automatic picking machines such as A-frames which can be loaded therewith. Alternatively, dispenser such as the ones known with A-frames can be used isolatedly (i.e. without an A-frame) for separating goods from the angular load support by dispensing. Alternatively, the goods can also be lifted vertically one time or several times by means of a lifting punch or piston, in order to allow the goods to be separated subsequently at an upper end of the angular load support by means of a pusher which pushes in a horizontal direction. In another alternative the angular load support can be used for picking with a robot by letting the robot grab the to-be-picked goods, e.g., vertically from above, preferably by means of a suction device.

Thus, the angular load support can be used universally with regard to the different known order-picking variations. The angular load support can be used universally with regard to storing processes and order-picking processes. The angle as such is preferably formed as construction kit by using slotted sidewalls, foldable sidewalls, foldable fixing bars, clickable fixing bars or the like (e.g. magnetically fixable bars).

With a preferred embodiment the angular load support comprises fixing bars wherein the support walls respectively comprise a plurality of recesses, wherein the plurality of recesses is arranged in accordance with a grid pitch so that the fixing bars can be placed close to the goods, and wherein each of the recesses is adapted for removably receiving one of the fixing bars.

In particular, the recesses are slot-shaped, wherein the fixing bars can be hung into the slots.

Further, it is advantageous if the recesses are additionally provided in the base.

With another advantageous embodiment, the base and one of the support walls comprise the recesses in terms of openings which are formed such that a circulating follower of a dispenser of a separation device passes the opening recurrently for pushing goods being stored in the angular load support in terms of a stack step-by-step so that goods which have not been pushed yet follow freely step-by-step due to gravity, thereby being provided for another delivery.

With still another preferred embodiment, the base comprises the at least one recess in terms of a hole which is adapted to allow passing of a separation device, preferably of a lifting punch, in order to lift stored goods within the angular load support.

As mentioned above, the separation device can be a dispensing unit. The dispensing unit can be provided alone or as a part of an automatic picking machine such as an A-frame.

The separation device can also be a lifting punch, in particular in combination with a pusher arranged at an upper end of the angular load support.

In accordance with a preferred embodiment, the angular load supports are adapted to be hung to an overhead conveyor, to be transported on a horizontal conveyor, to be stored in a shelf storage system and/or to be stacked with other angular load supports.

This allows the angular load supports to be used independent of the used type of conveyor. Existing systems can be retrofitted and/or enlarged.

If the angular load supports are adapted to be hung to an overhead conveyor, for example, individual dispensing units can be driven simply so that the dispensing units are arranged directly below the angular load supports.

Then, followers of the dispensing units can engage slots in the base of the angular load supports by means of suitable locking and positioning devices, which will be explained in more detail below, thereby pushing off stored goods from below in a horizontal manner. However, the angular load supports can be disconnected, e.g. manually, and then hung to the automatic picking machine (A-frame) as supply shafts. With another embodiment, for example, lifting punchs, instead of isolated dispenser devices, can be positioned below the angular load supports for reaching vertically through holes in the base of the angular load supports. Then, horizontally movable pushers can be provided in the intermediate vicinity of the upper edge of the angular load support, the pushers laterally pushing away as many goods as being lifted by the lifting punch.

Base area of the angular load support as such is preferably formed so that the angular load support can also be put on a horizontal conveyor such as a roller track or a belt conveyor, without tipping over during transportation. Then, the angular load supports also can be stored simply in shelf storage racks. Also, the base areas of the angular load supports can be formed so that preferably several ones of the angular load supports can be stacked on top of each other in an engaged manner. In this way, provided storage space is used optimally.

Further, it is advantageous if the storage area and the picking area are connected to each other, in terms of material flow, via at least one conveyor, in particular an overhead conveyor, a roller track and/or a belt conveyor.

In this case, the angular load supports can be conveyed from the warehouse to the order-picking stations or to the automated picking machines of the picking area, for example, by means of existing conveyors.

Another advantage is to be seen in that the storage area comprises racks, in particular shelf storage racks or hanging racks which are adapted for storing the angular load supports, or at least one circulating conveyor, in particular an overhead conveyor.

This again expresses the idea that already existing warehouses are compatible with the system of the invention, i.e. can be enlarged in particular with the system of the invention.

With another preferred embodiment, the sidewalls of the angular load supports protrude perpendicular from the base, and the fixing bars can be mounted in parallel relative to the sidewalls so that goods, which are stored by one single type only, take a recurrent and fixedly-defined position (preferably in the corner defined by the support walls) relative to the base, wherein the types of goods can vary in geometry.

This embodiment of the angular load supports allows an accurate positioning of the to-be-stored goods on the angular load supports so that, for example, robots can be used for picking. If robots are picking, it is necessary that the goods to be picked are provided at fixedly given positions relative to the angular load supports. The additional fixing bars serve this purpose, the additional fixing bars allowing to preset the position of the goods in a fixed manner including a sufficient tolerance range.

Even further, the angular load supports can also be used in known automatic picking machines (e.g. A-frames, M-Pemat, S-Pemat, etc.) in terms of supply magazines.

Also, it is advantageous, if the at least one recess is formed such that a fixing bar can be mounted in a variable manner at several positions relative to the base. Thus, the goods can be stored in a position-accurate manner, if possible at a preset storage position relative to the base.

As known, the to-be-picked goods do not have identical dimensions. In order to avoid a fixed assignment between the angular load supports and one of the types of goods to-be-stored, it is desired that the angular load supports can be used universally. This is achieved by the fixing bars, which can be mounted flexible with regard to the relative position thereof. For this purpose, a number of recesses in terms of grooves, deepenings, etc. can be provided in the sides of the angular load supports, for example, with a grid pitch which is preset in a fixed manner.

For example, a recess can be a slot, which preferably extends over the base and at least one of the sidewalls.

If the recess is formed in such a manner, both fixing bars and separation devices can cooperate with the angular load support, thereby again expressing the universality of the angular load support.

With another advantageous embodiment the angular load supports as such can have different dimensions.

This allows the angular load supports to adapt to different shapes of the goods to-be-stored.

It is clear that the above-mentioned and hereinafter still to be explained features can not only be used in the respectively given combination but also in other combinations or alone without departing from the scope of the present invention.

### BRIEF DESCRIPTION OF THE DRAWINGS

Embodiments of the invention are depicted in the drawings and will be explained in the description below, wherein:

FIG. 1 shows a block diagram of a storage and order-picking system in accordance with the present invention;

FIG. 2 shows a perspective view of a simple embodiment of an angular load support;

FIG. 3a perspectively shows another angular load support which cooperates with fixing bars in order to allow the goods to be positioned accurately in terms of locations;

FIG. 3b shows a top view of the angular load support of FIG. 3a;

FIG. 4 shows a perspective view of the angular load support of FIG. 3, wherein the fixing bars are omitted;

FIG. 5 shows a perspective view of another angular load support which is suitable for cooperating with a lifting punch;

FIG. 6 shows a perspective view of an angular load support being suitable for cooperating with a dispenser;

FIG. 7 shows a schematic top view of a first embodiment of the storage and order-picking system of the invention;

FIG. 8 shows a section of an application wherein the angular load supports are suitable for being transported by an overhead conveyor;

FIG. 9 shows an angular load support which is unloaded in an automated manner by means of a picking robot for the purpose of picking; and

FIG. 10 shows a second example of a storage and order-picking system of the invention.

### PREFERRED EMBODIMENTS OF THE INVENTION

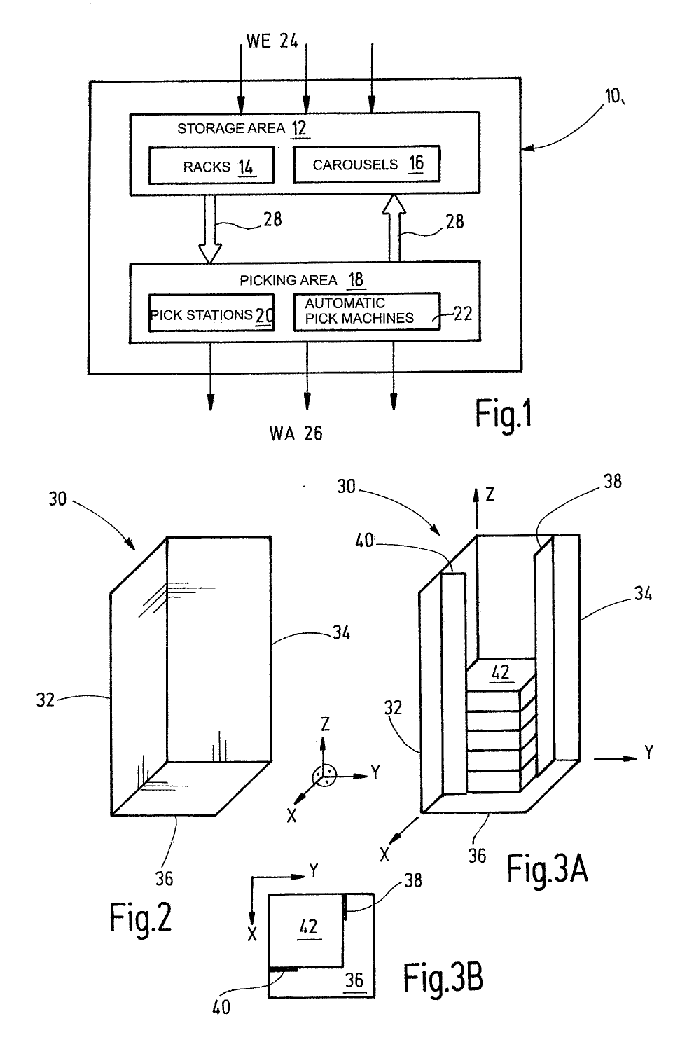

The storage and order-picking system is designated by 10 in the block diagram of FIG. 1.

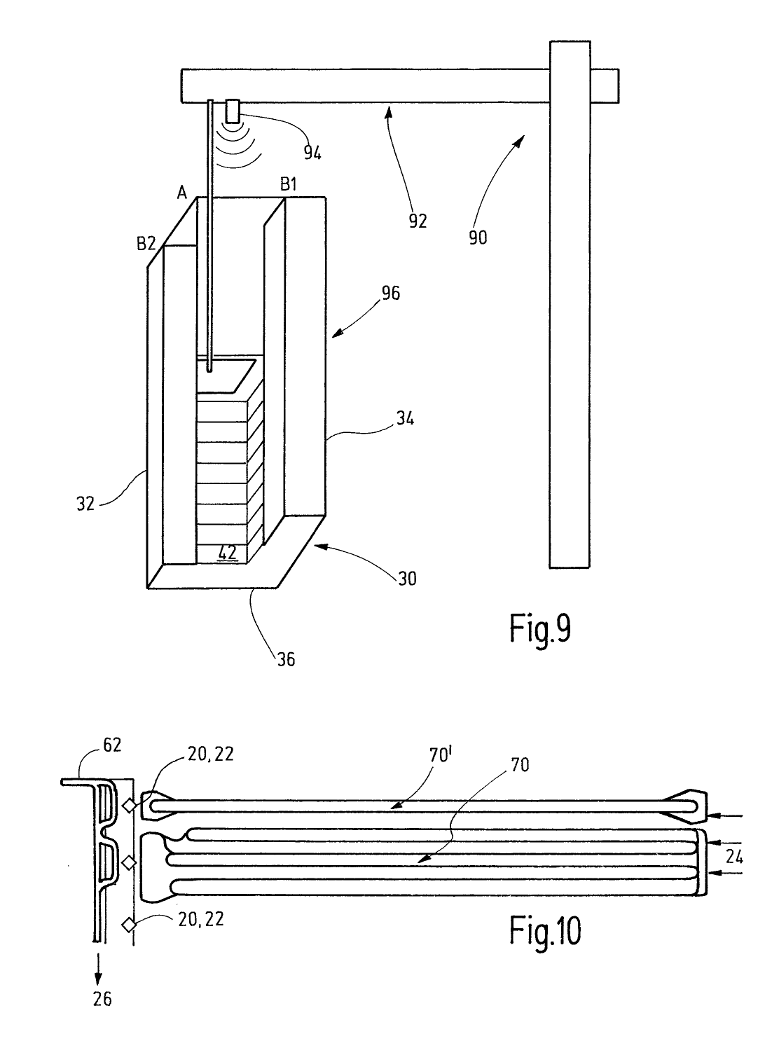

The storage and order-picking system 10 comprises a storage area 12, which in turn can comprise racks 14, carousels 16 and similar storage devices. The picking area 18 comprises one or more order-picking stations 20. Automatic picking machines 22 such as A-frames or picking robots (cf. FIG. 9) can be used alternatively or in addition. The order-picking stations 20 can be operated manually or in an automated manner. Separate dispensing units can be used at the order-picking stations 20, such as the ones being known from the A-frames. In addition, separation devices can be used, which comprise, for example, a lifting punch having a pusher which is provided in an upper area of the angular load supports and acts horizontally.

The storage area 12 is supplied with goods, which are to be picked, via a goods receipt 24. The goods receipt 24 is either coupled to the storage area 12 or is part of the storage area 12 as such, as will be explained hereinafter in more detail.

Goods which have been picked leave the storage and order-picking system 10 via a goods issue 26, which is either coupled to the picking area 18 or is part of the picking area 18.

The goods, which are to-be-picked, can be transferred between the storage area 12 and the picking area 18 by means of conveying devices 28, which are not shown in more detail here. The conveying devices 28 can be realized by a number of combined individual conveyor lines and/or an endlessly circulating distribution conveyor, which is connected to the storage area 12 and picking area 18 via corresponding terminal elements. All conventional conveyor types can be used for as the conveying devices 28 such as roller tracks, belt conveyors, overhead conveyors, chain conveyors, etc.

The present invention is based on the idea of using angular load supports 30 instead of conventional load supports such as containers or trays, the angular load supports 30 being described hereinafter in more detail in connection with FIGS. 2 through 6. The angular load supports 30 have the advantage that the goods in the goods receipt 24 are delivered such that they can be used by automatic picking machines, and then are neither touched nor changed in their position. Thus, the first rule of robotics is followed (“Once reached, never give up a state of order!”).

In this case, the conventional storage container is replaced by a longitudinal angle having three sides. The goods are stacked in this angle in terms of a vertical column.

The simplest type of an angular load support 30 is shown in FIG. 2. The angle 30 can be differently broad, long and high. The load support 30 shown in FIG. 2 can have, for example, 25×25×100 cm3. The angular load support generally comprises (exactly) three (base) sides 32, 34 and 36. The three sides comprise a first (vertical) support wall 32, a second (vertical) support wall 34 and a (horizontal) base 36. The sides 32-36 are preferably arranged perpendicular to each other as exemplarily indicated by means of a Cartesian coordinate system. It is clear that the support walls 32 and 34 are arranged preferably perpendicular relative to each other, wherein the alignment relative to the base 36 can be varied dependent on use. This refers to the slightly inclined supply shafts of an A-frame.

The simple angular load support 30 shown in FIG. 2 is, for example, suited for removal from above, e.g., by means of a picking robot.

A second embodiment of an angular load support 30 is shown in FIG. 3a which is only legibly different to the one shown in FIG. 2. The angular load support 30 of FIG. 3a additionally comprises fixing bars 38 and 40, which are substantially formed in two dimensions, the fixing bars allowing to secure such sides of goods 42 against unintended slipping, which are arranged oppositely to the support walls 32 and 34 in the angular load support 30. The fixing bars 38, 40 preferably are as high (compared to the direction Z) as the support walls 32 and 34, and are plate-like formed. Since the to-be-picked goods 42 typically have a regular geometry, the fixing bars 38 and 40 are preferably orientated in parallel relative to the support walls 32 and 34. However, the fixing bars 38 and 40 are significantly smaller than the support walls 32 and 34 so that sufficient space remains between the fixing bars 38 and 40, in order to load the angular load support 30 with goods 42, in particular in a manual manner. Typically, the fixing bars 38, 40 are installed not before the goods 42 are loaded. The fixing bars 38, 40 are pressed at the end against the stack of goods, e.g. by means of a tight engagement system comparable to a cable tie, remain in this position due to the engagement, and protect the stack against slipping-off.

As an alternative to the fixing bars mechanically engaging into the recesses of the support walls, the fixing bars comprising noses or similar for this purpose, the fixing bars can also be fixed flexibly to the support walls, for example, by means of magnetic or similar support elements (which are not shown). In this case there is no dependency on the grid pitch, and the fixing bars can be put very tightly to the goods so that the goods have an absolutely fixed position relative to the load support for the goods. In this case the support walls do not need to comprise recesses. The support walls are preferably made of metal so that the holding elements (e.g. permanent magnets at the back of the fixing bars) can directly interact with the support walls (magnetically). The support walls can also be made of a material which cannot be magnetized. In this case, for example, additional magnet supports would be provided oppositely to the holding elements of the fixing bars, the magnet supports being positioned at the back of the respective support wall.

The top view of FIG. 3b clearly shows that the fixing bars 38 and 40 are positioned as close as possible relative to the goods 42 so that the goods 42 cannot or hardly move relative to the base 36. The corner defined by the two support walls 32 and 34 is preferably used for orientating and positioning the goods 42 relative to the angular load support 30. This corner defines a preferred storage position of the goods 32. This is particularly relevant in cases where, for example, a robot is used for removing the goods 42. It is clear that this certainly applies in general to an automatic removal, independent of the usage of a robot or another technology. The only thing which counts is that a position of the goods 42 is known by the geometry of the angular load support 30 and the position of the fixing bars 38, 40 without elaborated image processing, which represents a prerequisite for automatic picking. The usage of robots requires an extremely accurate positioning and knowledge of the location of the goods 42 at the time of the automatic removal by the robot. Typically, the robot, which is not shown in the FIGS. 3a and 3b, in this situation picks the goods 42 from above, e.g. by means of a vacuum suction head. Thus, X-Y position of the goods 42 (relative to the angular load support 30) is always ensured. Alternatively, the corners defined by the support walls 32, 34 and the fixing bars 38 and 40 can be provided with additional markers A, B1 and/or B2, as shown exemplarily in FIG. 9 where the load support 30 of FIG. 3a is unloaded by means of a robot 90 which in this case can be provided additionally with a sensor 94 for detecting the markers A, B1 and/or B2 on its arm 92.

A superordinated control device such as a warehouse management computer, which is not shown in FIG. 9, can determine in advance, for example, based on inventory data, up to which height the angular load support 30 is loaded with the goods 42. This filling height 96, which is calculated from the dimensions of the goods 42, can be verified additionally by means of the sensor 94. The sensor 94 can be implemented, for example, by a cheap supersonic sensor or similar. If the goods 42 are retrieved, the height of the stack is decremented respectively about the height of one piece. Both methods (supersonic or counting) are sufficiently accurate for moving the robot 94 fast along the direction Z into the picking position. It is clear that the picking process, as discussed here, with the robot 90 only represents one of the plurality of possible picking alternatives.

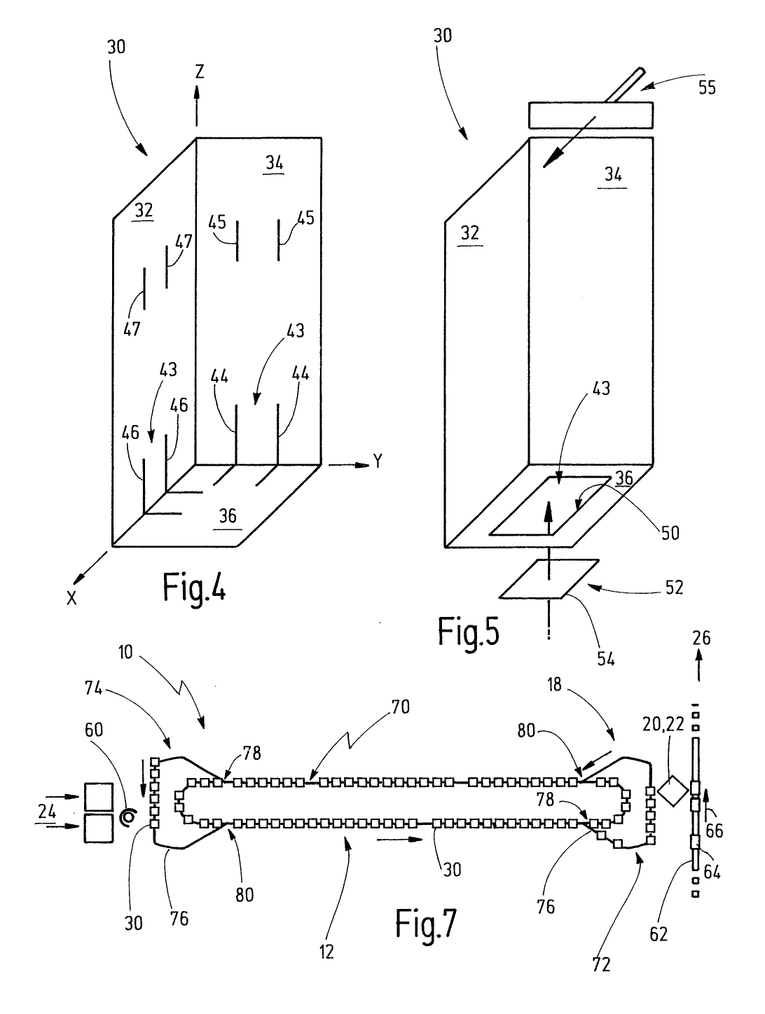

The angular load support 30 of FIGS. 3a and 3b is shown in FIG. 4 without the fixing bars 38 and 40 and without the goods 42. The sides 32, 34 and 36 of the angular load support 30, in this case, comprise a number of recesses 43 which are, for example, slot-shaped. A first pair of slots 44, here consisting of two slots, is provided in the second support wall 34 and the base 36. Further, a second pair of slots 45 is provided in the second support wall 34, wherein the slots 45 are displaced in the direction Z so that they correspond to the slots 44 in the direction Y. Similar is true for the third and fourth pair of slots 46 and 47 in the first support wall 32 and the base 36. The slots 44 through 47 are arranged preferably according to a predetermined grid pitch. It is clear that more than two slots can be provided in the direction X and/or the direction Y.

The fixing bars 38 and 40 which are not shown in FIG. 4 can be formed identically in order to keep the diversity of the used elements as low as possible. In the context of the angular load support 30 of FIGS. 3 and 4, for example, the fixing bars 38 and 40 are provided with nose-shaped protrusions (not shown), which can be hung into the slots 44-47. Elastic engagement noses and similar can be used as well.

It is clear that the smaller the grid pitch is, the better the fixing bars 38 and 40 can be placed closely to the goods 42, as shown exemplarily in FIG. 3b. Further, it is clear that the slots 44-47 can be provided at arbitrary locations and on arbitrarly many sides 32, 34 and 36, respectively. For example, it is not required necessarily to form the base 36 also slot-shaped. Additionally, it can be sufficient if each of the fixing bars is provided with only one single possibility of fixation for interacting with one of the sides 32 and/or 36or 34 and/or 36.

With reference to FIG. 5, another embodiment of an angular load support 30 is shown. The angular load support 30 of FIG. 5 is formed similar to the angular load support 30 of FIG. 1, wherein the base 36 comprises the recess 43 in terms of a hole 45. The hole 45 is adapted to allow passing of a separation device 52, in the present case implemented in terms of a lifting punch 54 being supported movably in the direction Z. In this case, the separation device 52 further comprises, for example, a pusher 55 movable in the direction X and/or Y for pushing off the goods 42 laterally from the angular load support 30, the goods 42 being lifted by means of the lifting punch 54. The angular load support 30 can be formed with or without the fixing bars 38, 40, and with or without the slots 44-47, as disclosed in the context of FIG. 4.

Further, the sidewalls 32 and 34 can be formed optionally like a telescope, which applies in general to the angular load supports 30, which are shown here. The support walls 32 and 34 can also be supported pivotally, in order to be pivoted out of their support position for the purpose of a removal 42. A removal can also be performed in an overhead operation of the angular load support 30.

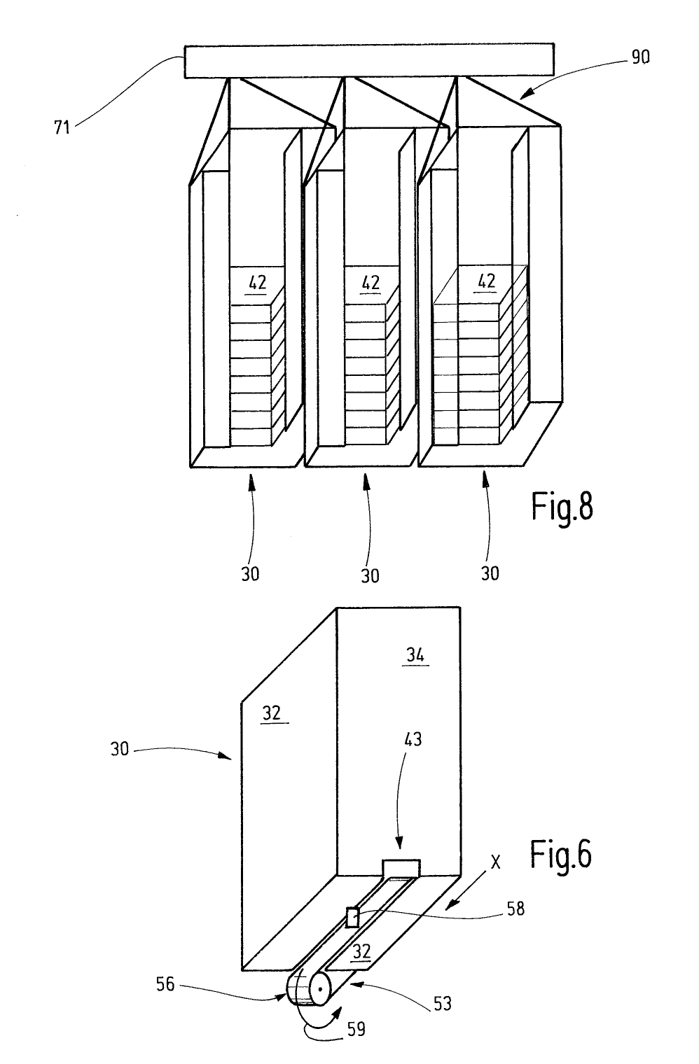

With reference to FIG. 6 another embodiment of an angular load support 30 is shown.

The angular load support 30 of FIG. 6 comprises the opening 43 in the base 36 and one of the support walls 32 or 34 (in this case in the support wall 34). The recess 43 serves the interaction of the angular load support 30 with another separation device 52, in this case implemented in terms of an isolated dispenser 56 such as the ones used with A-frames. The dispenser device 56 comprises a circulating follower 58, which reaches through the recess 43 and repeatedly passes the recess 43 along the longitudinal direction (direction X) thereof in the direction of an arrow 59. In this manner the goods 42, which are stored in terms of a stack in the angular load support 30, can be pushed off step-by-step. Then, the remaining goods 42 follow due to gravity, and thus are provided for the next delivery.

It is clear that the operation in connection with the dispenser device 56 requires a certain degree of accurately positioning the angular load support 30 relative to the dispenser device 56. This can be achieved, for example, by means of a stopper, which is not shown here, or a retention jaw, which is not shown here, locking the angular load support 30, for example, at the support walls 32 and 34 in order to hold the recess 43 accurately above the circulating follower 58.

It is clear that the angular load support 30 of FIG. 6 can also be equipped with the fixing bars 38 and 40. Further, a number of recesses 43 can be provided for a plurality of ejections being parallel and horizontal.

With reference to FIG. 7 a schematic top view of a first specific embodiment of a storage and order-picking system 10 in accordance with the invention is shown. The storage area 12 shown schematically in FIG. 1, in this case, merges seamlessly into the picking area 18 since an endlessly circulating conveyor 70, which will be described hereinafter in more detail, is used between the goods receipt 24, which is operated, for example, manually by means of a worker 60, and the goods issue 26.

Incoming goods 24 are transferred, for example, manually to empty load supports 30 at the goods receipt 24. In the picking area 18, where the order-picking stations 20 or the automatic picking machines 22 are provided as well, an order-container conveyor 62 is exemplarily provided, by the aid of which order containers 64 can be transported in a transportation direction 66 towards the goods issue 26 as soon as the orders are processed, being respectively assigned to the order containers 64.

In this case, for example, an endlessly circulating horizontal conveyor 70 in terms of, for example, an overhead conveyor 71, such as the one shown exemplarily in FIG. 8, is provided for bringing the goods 42 in the manually loaded angular load supports 30 from the goods receipt 24 to the order-picking stations 20 or to the automatic picking machines 22. Then, the angular load supports 30 are provided with a corresponding suspension 90 for being hung to the overhead conveyor 71 and for being decoupled therefrom.

Returning to FIG. 7 the angular load supports 30 are transported along the direction of the small dark arrows (in this case against the clockwise direction). So-called “train stations” 72 and 74 connect to the conveyor 70 in the area of the goods receipt 24 or in the area of the order-picking stations and the automatic picking machines 22. Both the train station 72 in the area of the order-picking stations 20 or the automatic picking machines 22, and the train station 74 in the area of the additional receipt 24 comprise a loop-like conveyor 76 (in this case also in terms of an overhead conveyor), which is connected respectively to the endlessly circulating conveyor 70, in terms of material flow, via a feeding point 78 and a discharging point 80. Loaded and empty angular load supports 30 can circulate arbitrarily often in the conveyor 70 before they are guided to one of the train stations 72 and 74. The empty angular load supports 30 are guided to the train station 74 for being filled with the goods 42. Full angular load supports 30 are guided to the train station 72 for the purpose of being picked with the goods 42. There, the goods 42 can either be retrieved manually or in an automated manner such as already explained exemplarily in connection with FIGS. 2 through 6. However, the angular load supports 30 can also be decoupled completely and put into an A-frame, which however is associated with additional operation steps. It is better to leave the overhead conveyor 30 of FIG. 6 in the train station 72 and to position the dispenser device 56 so that the dispenser sits directly beneath the angular load supports 30. In this case direct delivery of the goods 42 is possible.

It is clear that the diamond symbol illustrated in FIG. 7 merely indicates the option of a plurality of different order-picking solutions. Also, the shown position of the order-container conveyor 62 relative to the train station 72 is chosen randomly. For example, if a dispenser device 56 is used, such as the one described above, it is recommended to position the order-container conveyor 62 relatively close to the train station 72 or the order-picking stations 20 so that the discharged goods 42 land directly in the order container 64.

Here, the conveyor 70 simultaneously is a warehouse and part of the automated order-picking process. Different technologies (dispenser device, robots, pick-by light, etc.) can be used.

The system of FIG. 7 can be scaled, as can be taken clearly from FIG. 10. Overhead conveyors receive the angular load supports 30, which are not illustrated here, and generate a connection between the goods receipt 24 and the order-picking stations 20 or the automatic picking machines 22. In dependence on picking frequency or other characteristics of the products (size, weight, shape, etc.) specific angular load supports 30 or overhead conveyors including such angular load supports 30 are used. The number of windings of a carousel can be varied. The overhead conveyors can be formed as single loops or multiple loops. In this case, decoupled tracks are provided for connecting the order-picking stations and the goods receipt.

The order containers 64 of the conveyor 62 can also be connected to the respective order-picking stations 20 or automatic picking machines 22 in terms of train stations. It is clear that containers 64 for receiving the orders do not need to be provided necessarily. In principle, any arbitrary type of load support can be used (such as cartons, pallets, etc.).

The system of the present invention can be used in manifold manners. For example, it can be used for: order-picking with robots, order-picking with A-frames, in the context of limpy goods (such as shrink-wrapped polo shirts) and with many other similar applications.

The storing process and the order-picking process are melted together by the present approach. Almost all of the logistic requirements can be covered by the variations of the angular load support dimensions and the types of angles or the conveyor technology used for this purpose, namely from fast movers to the handling of returned goods. The angular load supports 30 can be stackable. The angular load supports 30 as such can be part of angular load support dispensing devices (not shown). The angular load supports 30 can be hung like containers in a shelf or specifically adapted racks.

Therefore, what we claim is:

1. A storage and order-picking system comprising:
a storage area;
a picking area; and
a plurality of angular load supports, which are used for both storage of goods and transportation of the goods between the storage area and the picking area;
wherein each of the angular load supports comprises at least one fixing bar and has three sides, wherein the sides are substantially orientated perpendicular to each other and define a first support wall, a second support wall and a base for storing the goods in stacks;
wherein the support walls respectively comprise a plurality of recesses so that the at least one fixing bar can be placed closely to the goods, and wherein each of the recesses is adapted for removably receiving the at least one fixing bar; and
wherein the sidewalls protrude column-like from the base, and the at least one fixing bar is mountable in parallel relative to one of the sidewalls so that the goods, which are stored by one sort only in the angular load support, occupy a repeating and fixedly defined position relative to the base.

2. The system of claim 1, wherein the recesses are arranged in accordance with a grid pitch.

3. The system of claim 1, wherein each of the recesses is a slot into which the at least one fixing bar can be hung.

4. The system of claim 1, wherein the recesses are also provided in the base.

5. The system of claim 1, further comprising a separation device for separating the goods form one of the angular load supports, the separation device including a dispenser device having a circulating follower, wherein the base and one of the support walls comprise an additional opening which is formed such that the circulating follower of the dispenser device of the separation device passes the opening repeatedly in order to dispense the goods which are stored in a stackwise manner in the angular load support.

6. The system of claim 1 further comprising a separation device, wherein the base comprises a hole which is adapted to allow passing of the separation device, in order to lift the goods being stored in the angular load support.

7. The system of claim 6, wherein the separation device is a lifting punch.

8. The system of claim 6, wherein the separation device comprises a lifting punch and a pusher, wherein the pusher is arranged such that lifted goods can be pushed off laterally at an upper rim of the angular load support.

9. The system of claim 1 further comprising at least one element of a group which includes an overhead conveyor, a steady conveyor, and a shelf, wherein the angular load supports are adapted: for being hung to the overhead conveyor; for being transported on the steady conveyor; for being stored in the shelf and for being stacked with each other.

10. The system of claim 1, wherein the storage area and the picking area are connected to each other via at least one conveyor.

11. The system of claim 10, wherein the at least one conveyor is selected from the group including an overhead conveyor, a roller track and a belt conveyor.

12. The system of claim 1, wherein the storage area comprises racks being adapted for storing the angular load supports.

13. The system of claim 1 comprising least one circulating conveyor.

14. An angular load support for storing and transporting goods in stacks comprising:
at least one fixing bar; and
three sides, wherein the sides are substantially orientated perpendicular to each other and define a first support wall, a second support wall and a base for storing the goods in stacks; and
wherein the support walls respectively comprise a plurality of recesses so that the at least one fixing bar can be placed closely to the goods, and wherein each of the recesses is adapted for removably receiving the at least one fixing bar.

15. The angular load support of claim 14, wherein the sidewalls protrude column-like from the base, and the at least one fixing bar is mountable in parallel relative to one of the sidewalls so that the goods, which are stored by one sort only in the angular load support, occupy a repeating and fixedly defined position relative to the base.

16. The angular load support of claim 14, wherein the recesses are arranged in accordance with a grid pitch.

17. The angular load support of claim 14, wherein each of the recesses is a slot into which the at least one fixing bar can be hung.

18. The angular load support of claim 14, wherein the recesses are also provided in the base.

19. An angular load support for storing goods, comprising:
three sides, which are substantially arranged in right angles to each other and which define a first support wall, a second support wall and a base for storing the goods in stacks,
wherein at least one of the three sides of at least some of the angular load supports comprises a recess.

20. The angular load support of claim 19, wherein the recess is adapted to removably receive a fixing web.

21. The angular load support of claim 19, wherein the recess is adapted to allow a separation device of an automated order-picking unit to reach through the recess.

22. The angular load support of claim 19, wherein the base comprises a hole allowing a separation device of an automated order-picking unit to reach through the hole.

23. The angular load support of claim 19 further comprising fixing bars, wherein the fixing webs are mounted variablely to the support walls by means of magnetic support elements.
